(19) United States
(12) Patent Application Publication
(10) Pub. No.: US 2024/0260781 A1
(43) Pub. Date: Aug. 8, 2024

(54) APPARATUS AND METHOD FOR AUTOMATED PREPARATION AND DELIVERY OF BEVERAGES

(71) Applicant: Appliance Innovation, Inc., Richardson, TX (US)

(72) Inventors: PHILIP R. MCKEE, DALLAS, TX (US); HAROLD HANSEN, PLANO, TX (US); ANDREW PODEVELS, WAUWATOSA, WI (US); SCOTT SMITH, RICHARDSON, TX (US); ANTHONY SAYAS, WYLIE, TX (US); HARMEET JAMMU, SACHSE, TX (US)

(21) Appl. No.: 18/105,474

(22) Filed: Feb. 3, 2023

(51) Int. Cl. A47J 31/00; A47J 31/44; A47J 31/52; G06Q 10/0836; G06Q 50/12

(52) U.S. Cl. CPC A47J 31/007; A47J 31/4403; A47J 31/5253; G06Q 10/0836; G06Q 50/12; B65G 1/04

(57) ABSTRACT

An apparatus and method for automated preparation and delivery of a beverage. A first cup-transfer-mechanism is configured to receive a cup from a cup dispenser and to move the cup along a first axis within the apparatus during the preparation of the beverage. A second cup-transfer mechanism is configured to receive the cup containing the beverage from the first cup-transfer mechanism after the beverage has been prepared, wherein the second cup-transfer mechanism is configured to move the cup along at least one of a second axis and a third axis within the apparatus, wherein the first axis, the second axis, and the third axis are mutually perpendicular. A pick-up station where the customer picks up its beverage is configured to receive the cup from the second cup-transfer mechanism and to make room to receive subsequent cups without requiring human interaction. Multiple beverages can be prepared and delivered simultaneously.

### CROSS-REFERENCE TO RELATED APPLICATION

The present non-provisional patent application is related to U.S. patent application Ser. No. 18/______, which was filed on even date and is assigned to the assignee of the present application.

### FIELD OF THE INVENTION

The present invention generally relates to apparatus and methods for the automated preparation and delivery of beverages ordered by a customer. In particular, the present invention relates to the preparation and delivery of a wide range of beverage offerings without human involvement from a location that occupies a small amount of space.

### BACKGROUND OF THE INVENTION

Upscale retail beverage locations, such as coffee shops, now offer a wide range of products that are freshly made in response to a single customer order. For example, customer selected coffee beans are often freshly ground. Creamers, sweeteners, steamed milks, flavorings and the like are added per customer specifications. Premium iced coffees made from customer selected beans are brewed to order from freshly ground beans before ice is added. These premium beverage offerings require a wide range of equipment to prepare. However, upscale retail beverage shops are frequently located in high traffic areas, where rents are high. As such, available space for customer ordering, beverage preparation and beverage pickup is limited. In addition, high beverage throughput is required in high traffic locations, where many customers are in a hurry and expect short service times.

Accordingly, there is a need for an improved beverage delivery apparatus and methods which overcomes the problems identified above.

### SUMMARY OF THE INVENTION

The present invention generally relates to an apparatus and method for automated preparation and delivery of beverages (e.g., coffee, tea, alcoholic spirits) which has multiple, interchangeable beverage dispensing systems and is thus capable of preparing and serving a wide range of high-quality beverage products at a high throughput without human assistance. In accordance with exemplary embodiments of the present invention, a single machine can offer a broad range of beverages (e.g., an entire STARBUCKS-type beverage offering) at a small location (e.g., within a convenience store) without the need for a human being to prepare and distribute the beverages.

In accordance with an exemplary embodiment of the present invention, an apparatus for automated preparation and delivery of a beverage ordered by a customer includes a plurality of cup dispensers, wherein at least one of the plurality of cup dispensers is configured to dispense a cup which is appropriate to contain the beverage ordered by the customer; a first cup-transfer-mechanism configured to receive the cup from one of the plurality of cup dispensers and to move the cup along a first axis within the apparatus during the preparation of the beverage ordered by the customer; a second cup-transfer mechanism configured to receive the cup containing the beverage ordered by the customer from the first cup-transfer mechanism after the beverage has been prepared, wherein the second cup-transfer mechanism is configured to move the cup along at least one of a second axis and a third axis within the apparatus, wherein the first axis, the second axis, and the third axis are mutually perpendicular; and a pick-up station from which the cup containing the beverage ordered by the customer is picked up by the customer. The pick-up station is configured to receive the cup containing the beverage ordered by the customer from the second cup-transfer mechanism and to make room to receive subsequent cups without requiring human interaction.

In embodiments, the pick-up station includes a conveyor.

In embodiments, the apparatus comprises at least one front door and the conveyor is located on the at least one front door.

In embodiments, the conveyor rotates such that the cup containing the beverage ordered by the customer is dropped from the conveyor if the customer has not picked up the cup containing the beverage ordered by the customer from the conveyor within an allotted amount of time.

In embodiments, the apparatus includes two pick-up stations which are located at least about 2.5 feet from each other.

In embodiments, each of the two pick-up stations includes a conveyor.

In embodiments, each of the conveyors rotates such that the cup containing the beverage ordered by the customer is dropped from the conveyor if the customer has not picked up the cup containing the beverage from the conveyor within an allotted amount of time.

In embodiments, the allotted amount of time is extended by delivering the cup containing the beverage ordered by the customer to a first one of the two pick-up stations and alternating delivery of subsequently ordered beverages between a second one of the two pick-up stations and the first one of the two pick-up stations.

In embodiments, the apparatus includes a plurality of first cup-transfer mechanisms.

In embodiments, the apparatus includes two first cup-transfer mechanisms.

In embodiments, the apparatus includes a plurality of second cup-transfer mechanisms.

In embodiments, the apparatus includes two second cup-transfer mechanisms, each of the two second cup-transfer mechanisms being disposed at an opposite end of the first axis of the apparatus.

In embodiments, the second cup-transfer mechanism moves the cup containing the beverage ordered by the customer along the second axis and/or the third axis to place the cup on the conveyor.

In embodiments, each of the two first cup-transfer mechanisms handles cups having different top diameters.

In embodiments, the bottoms of the cups that extend from each of the plurality of cup dispensers are in the same horizontal plane.

In embodiments, the first cup-transfer mechanism and the second cup-transfer mechanism are located above the cup containing the beverage ordered by the customer.

In embodiments, the apparatus includes a controller and an infrared camera coupled to the controller to verify one or more of: the size of the cup that contains the beverage ordered by the consumer, the level of the beverage contained within the cup, and the approximate temperature of the beverage contained within the cup.

In embodiments, each of the plurality of cup dispensers includes a turret assembly configured to hold a plurality of sleeves of cups, and when the cup dispenser has dispensed all of the cups from a first sleeve of the plurality of sleeves of cups held in the turret assembly, the turret assembly moves a second sleeve of the plurality of sleeves of cups held in the turret assembly into a position where the cup dispenser can dispense cups from the second sleeve.

In embodiments, the turret assembly is readily removable from and attachable to the apparatus.

In embodiments, the apparatus includes at least one door granting access to the pick-up station.

In embodiments, access to the pick-up station via the at least one door is granted only to the customer.

In embodiments, the apparatus includes at least one door granting access to the pick-up station, wherein the at least one door is locked when the conveyor is moving.

In embodiments, the apparatus includes a display which notifies the customer when the at least one door is about to be locked, when the at least one door is locked, and/or when the at least one door can be opened.

In accordance with an exemplary embodiment of the present invention, a method for automated preparation and delivery of a beverage ordered by a customer includes dispensing a cup which is appropriate to contain the beverage ordered by the customer; receiving the cup in a first cup-transfer-mechanism; moving the cup along a first axis by the first cup-transfer mechanism during preparation of the beverage ordered by the customer; transferring the cup containing the beverage ordered by the customer from the first cup-transfer mechanism to a second cup-transfer mechanism after the beverage has been prepared, wherein the second cup-transfer mechanism is configured to move along at least one of a second axis and a third axis, wherein the first axis, the second axis, and the third axis are mutually perpendicular; receiving the cup with the beverage ordered by the customer from the second cup-transfer mechanism at a location from which the cup containing the beverage ordered by the customer is picked up by the customer; and making room at the location to receive subsequent cups without requiring human interaction.

In embodiments, the step of receiving the cup with the beverage ordered by the customer from the second cup-transfer mechanism at a location from which the cup containing the beverage ordered by the customer is removed by the customer includes placing the cup containing the beverage ordered by the customer on a conveyor using the second cup transfer mechanism.

In embodiments, the method includes the step of rotating the conveyor such that the cup containing the beverage ordered by the customer is dropped from the conveyor if the customer has not picked up the cup containing the beverage ordered by the customer from the conveyor within the predetermined period of time.

In embodiments, the method includes placing the cup containing the beverage ordered by the customer on the conveyor by moving the cup along the second axis and/or the third axis.

In embodiments, the method includes providing a plurality of locations from which the cup containing the beverage ordered by the customer can be picked up by the customer.

In embodiments, each of the plurality of locations includes a conveyor.

In embodiments, the method includes the step of handling, by the first cup-transfer mechanism, cups having different top diameters.

In embodiments, the dispensing step includes dropping the cup from a predetermined distance that remains constant regardless of a size to the cup.

In embodiments, the method includes the step of locating the first cup-transfer mechanism and the second cup-transfer mechanism above the cup containing the beverage ordered by the customer.

In embodiments, the method includes the step of verifying one or more of: the size of the cup that contains the beverage ordered by the consumer, the level of the beverage contained within the cup, and the approximate temperature of the beverage contained within the cup.

In embodiments, the dispensing step includes holding a plurality of sleeves of cups in a turret assembly, and when all of the cups from a first sleeve of the plurality of sleeves of cups held in the turret assembly have been dispensed, moving a second sleeve of the plurality of sleeves of cups held in the turret assembly into a position where cups from the second sleeve can be dispensed.

In embodiments, the method includes the step of granting access to the pick-up station via at least one door.

In embodiments, access to the pick-up station via the at least one door is granted only to the customer.

In embodiments, the method includes granting access to the pick-up station via at least one door and locking the at least one door when the conveyor is moving.

In embodiments, the method includes the step of notifying the customer when the at least one door is about to be locked, when the at least one door is locked, and/or when the at least one door can be opened.

In accordance with an exemplary embodiment of the present invention, an apparatus for automated preparation and delivery of a beverage ordered by a customer includes a plurality of cup dispensers, wherein at least one of the plurality of cup dispensers is configured to dispense a cup which is appropriate to contain the beverage ordered by the customer; a cup-transfer mechanism configured to receive the cup and to move the cup along a first axis within the apparatus during the preparation of the beverage ordered by the customer; and a laser configured to mark information about the beverage ordered by the customer directly onto the cup, whereby an operator of the apparatus can charge the customer based on the information.

In embodiments, the information identifies specific ingredients of the beverage ordered by the customer.

In embodiments, the information includes a barcode.

In embodiments, the information includes a QR code.

In accordance with an exemplary embodiment of the present invention, a method for automated preparation and pick-up of a beverage ordered by a customer includes dispensing a cup which is appropriate to contain the beverage ordered by the customer; receiving the cup in a first cup-transfer mechanism; moving the cup along a first axis by the first cup-transfer mechanism during preparation of the beverage ordered by the customer; and marking information about the beverage ordered by the customer directly onto the cup, whereby an operator of the apparatus can charge the customer based on the information.

In embodiments, the information identifies specific ingredients of the beverage ordered by the customer.

In embodiments, the information includes a barcode.

In embodiments, the information includes a QR code.

In exemplary embodiments, the method further includes scanning the barcode or the QR code at a point-of-sale system.

The features, functions, and advantages can be achieved independently in various embodiments of the present invention or may be combined in yet other embodiments in which further details can be seen with reference to the following description and drawings.

### BRIEF DESCRIPTION OF THE DRAWINGS

The following detailed description, given by way of example and not intended to limit the present invention solely thereto, will best be understood in conjunction with the accompanying drawings in which:

FIG. 1 is a front view of an apparatus for preparing and delivering beverages in accordance with an exemplary embodiment of the present invention.

FIG. 2 illustrates an exemplary screen presented by the apparatus shown in FIG. 1 for ordering a beverage.

FIG. 3 illustrates an exemplary screen presented by the apparatus shown in FIG. 1 for tracking the progress of a beverage order that is being prepared.

FIG. 4 illustrates an exemplary screen presented by the apparatus shown in FIG. 1 which displays the order queue and shows which customers' orders are ready to be picked up at which pick-up points of the apparatus.

FIG. 5A depicts interior components and systems of the apparatus shown in FIG. 1 for preparing and delivering beverages in accordance with an exemplary embodiment of the present invention.

FIG. 5B depicts aspects of cup turret assemblies used in the apparatus shown in FIG. 1 for preparing and delivering beverages in accordance with an exemplary embodiment of the present invention.

FIG. 5C depicts first cup-transfer mechanisms and second cup-transfer mechanisms used in the apparatus shown in FIG. 1 for preparing and delivering beverages in accordance with an exemplary embodiment of the present invention.

FIGS. 6A-6C illustrate the transfer of a cup from a first cup-transfer mechanism to a second cup transfer mechanism in accordance with an exemplary embodiment of the present invention.

FIGS. 6D-6F illustrate the transfer of a cup from the second cup-transfer mechanism to placement at a beverage pick-up station in accordance with an exemplary embodiment of the present invention.

FIG. 7 depicts automated conveyors used in the apparatus shown in FIG. 1 for preparing and delivering beverages in accordance with an exemplary embodiment of the present invention.

FIG. 8 shows a block diagram of connections between a system controller and various components in an apparatus for preparing and delivering beverages in accordance with an exemplary embodiment of the present invention.

FIG. 9 illustrates a process for preparing and delivering multiple beverages simultaneously in accordance with an exemplary embodiment of the present invention.

FIG. 10 illustrates another process for preparing and delivering multiple beverages simultaneously in accordance with an exemplary embodiment of the present invention.

### DETAILED DESCRIPTION OF EXEMPLARY EMBODIMENTS

In the present disclosure, like reference numbers refer to like elements throughout the drawings, which illustrate various exemplary embodiments of the present invention.

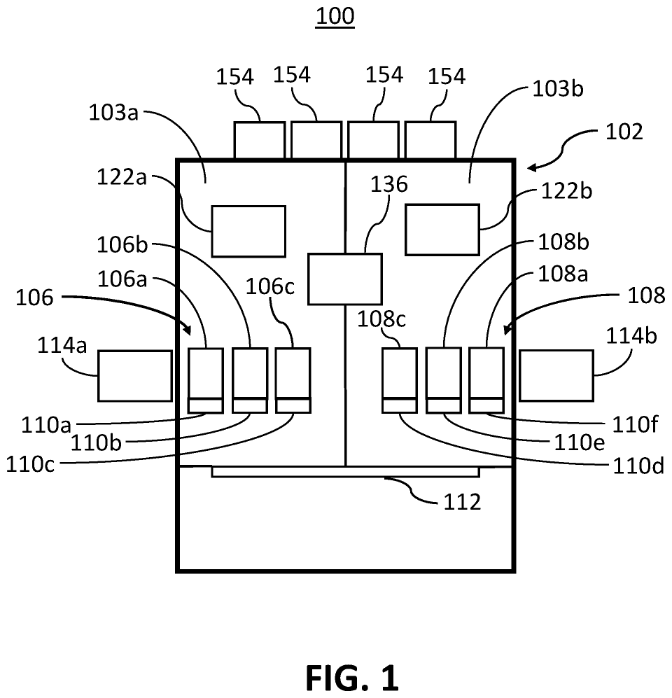

Referring now to the drawings and in particular to FIG. 1, there is depicted an exemplary embodiment of an apparatus 100 for automated preparation and delivery of a beverage ordered by a customer. Certain of the components of apparatus 100 (which will be described in detail further herein) are located within a housing 102 and are not visible. (Among those components which are partially visible in FIG. 1 are cup turret assemblies 154.) A customer accesses one beverage at a time at either a left pick-up station 106 or a right pick-up station 108. Each pick-up station 106, 108 has three pick-up points 106a-106c, 108a-108c. A customer accesses his or her beverage at one of the pick-up points 106a-106c, 108a-108c through a corresponding door 110a-110c, 110d-110f. (Although FIG. 1 shows that each pick-up station 106, 108 has three pick-up points and three corresponding access doors, alternative embodiments can include more or fewer pick-up points and access doors (e.g., two or four)). The housing 102 includes a shelf 112 located below the pick-up stations 106, 108 where a customer can put one beverage when accessing a second beverage.

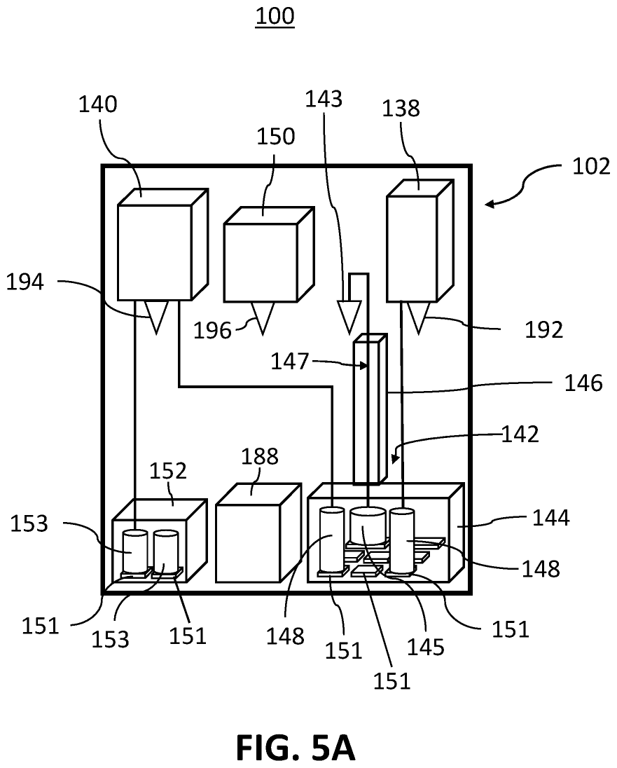

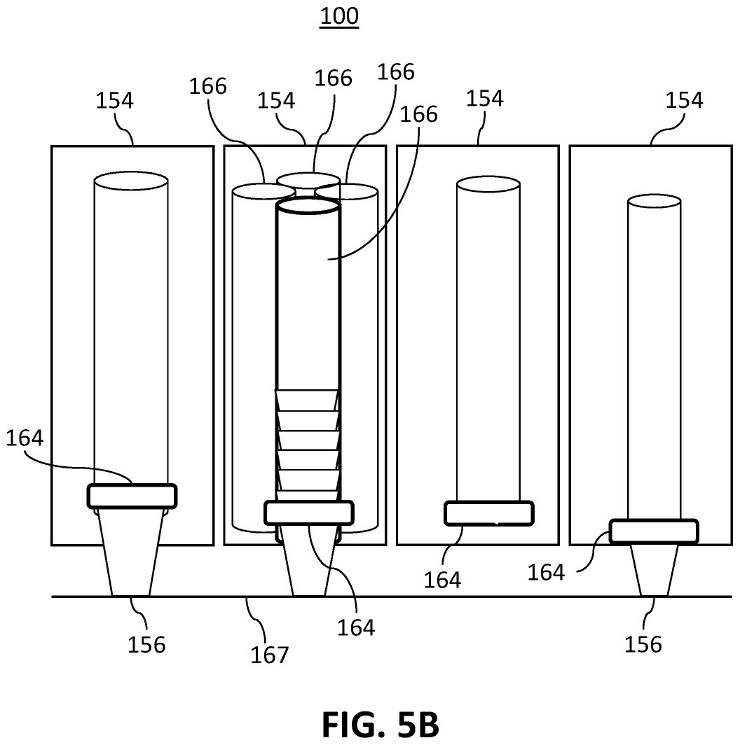

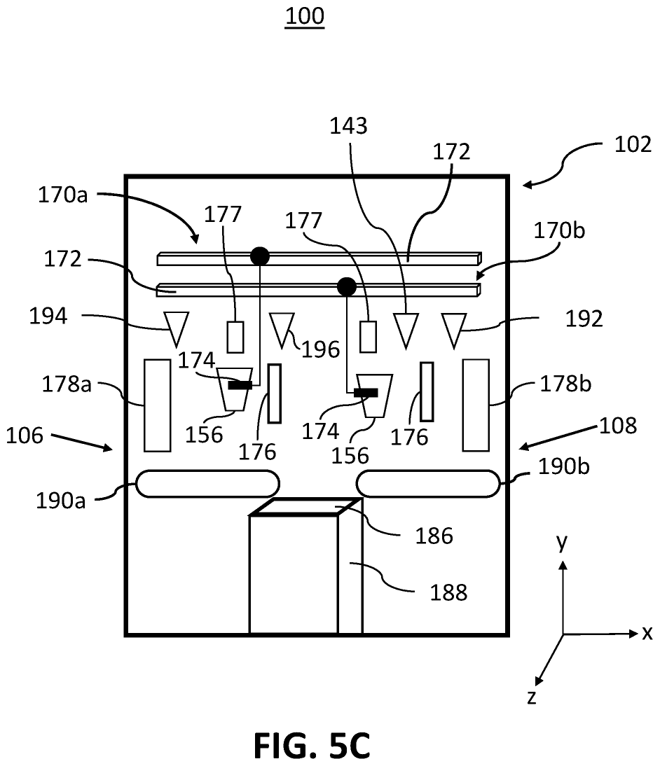

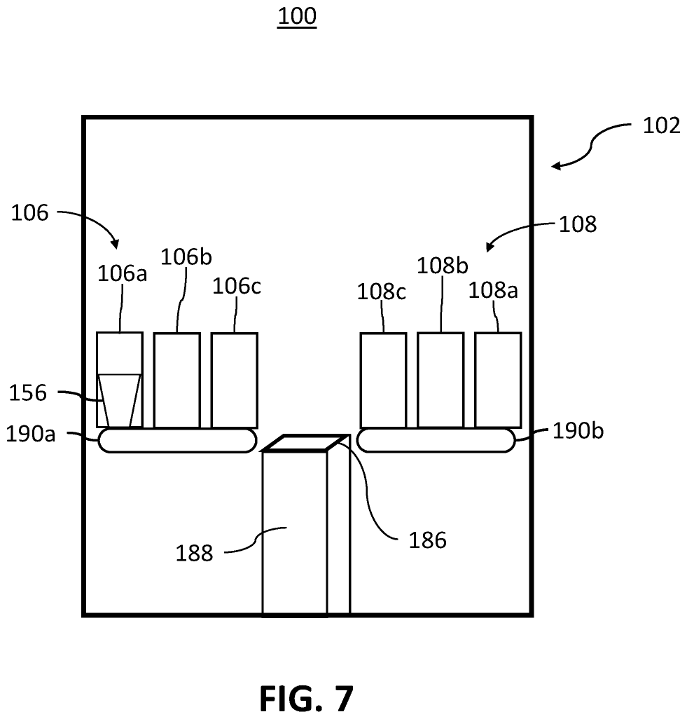

As shown in FIG. 1 (and also in FIGS. 5C and 7), in a preferred embodiment, beverage pick-up stations 106, 108 are located on opposite sides of apparatus 100 along the x-axis of apparatus 100. In a preferred embodiment, beverage pick-up stations are located at least about 2.5 feet from each other along the x-axis of apparatus 100. This wide separation between beverage pick-up stations 106, 108 provides an attractive feature of apparatus 100 for customers who wish to avoid dealing with crowds when they pick up their beverages.

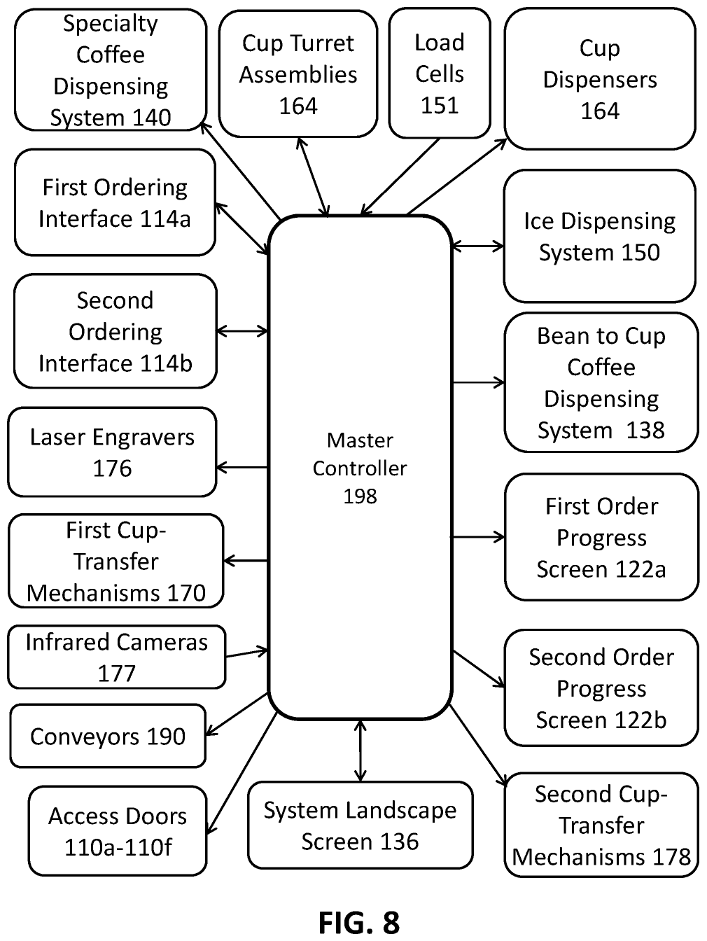

The apparatus 100 includes a first ordering interface 114a and a second ordering interface 114b which accept a customer's order, send the order to a master controller 198 of the apparatus 100, and receive status information from the master controller 198 (see FIG. 8). As shown in FIG. 1, the first and second ordering interfaces 114a, 114b can be located in physical proximity to the housing 102 or attached to the housing 102. The first and second ordering interfaces 114a, 114b are preferably implemented with a touch-screen display, but they can also be implemented using other suitable means. The first and second ordering interfaces 114a, 114b can also be implemented remotely, such as by a customer's mobile phone, a computer tablet, desktop or laptop computers, smartwatches, or any other devices that have access to apparatus 100 over the Internet.

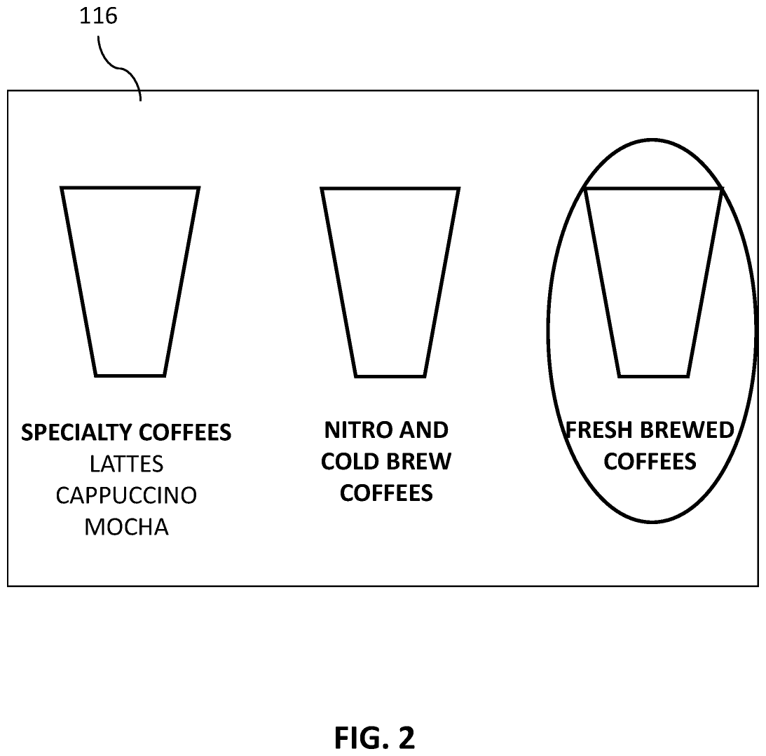

First ordering interface 114a and second ordering interface 114b each display a series of screens according to a predetermined beverage selection pattern to facilitate the customer's order of a customized beverage. As shown in FIG. 2, an initial ordering screen 116 may have a customer select from Fresh Brewed Coffees, Nitro and Cold Brew Coffees, and Specialty Coffees (e.g., Latte, Cappuccino, Mocha) by touching the portion of first ordering interface 114a (or second ordering interface 114b) that corresponds to the desired beverage. If the customer selects Fresh Brewed Coffees (as indicated by the circle around “Fresh Brewed Coffees” in screen 116), first ordering interface 114a (or second ordering interface 114b) asks the customer to choose between up to four different types of coffee beans and to select the size of the beverage. Finally, when the customer has completed ordering the beverage, the first ordering interface 114a (or second ordering interface 114b) informs the customer that its order has been submitted and the beverage is being prepared. Similarly, first ordering interface 114a and second ordering interface 114b each display a series of screens according to predetermined beverage selection patterns for Nitro (or just Cold Brew) and Specialty coffees to facilitate the customer's ordering and customizing of those beverages.

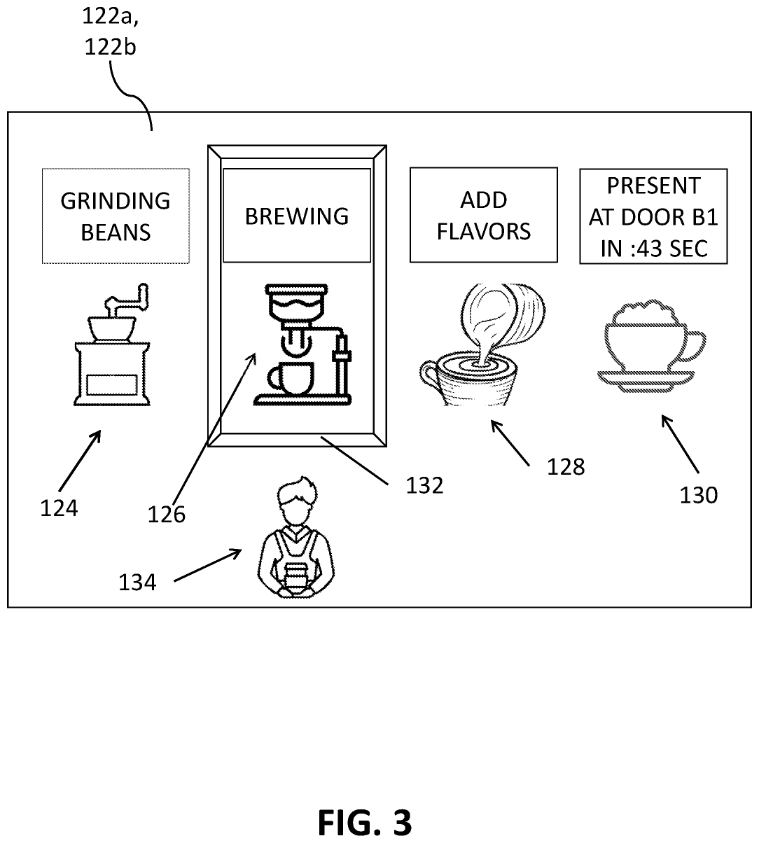

Referring now to FIG. 3, apparatus 100 also includes a first order progress screen 122a and a second order progress screen 122b which display the status of customers' orders that are currently being prepared by apparatus 100. The order progress screens 122a, 122b display the steps that apparatus 100 performs to prepare a beverage that has been ordered by a customer and the progress of the performance of those steps by apparatus 100. Each order progress screen 122a, 122b provides the status of a separate beverage order. Exemplary graphical representations 124, 126, 128, 130, 132, 134 of the progress of the preparation of a coffee beverage can be displayed on order progress screens 122a, 122b for various different beverages. As shown in FIG. 3, the steps of grinding coffee beans, brewing coffee, adding flavors, and transferring a cup to a particular door 110a-110f at pick-up stations 106, 108, which are performed to prepare the coffee beverage, are displayed on order progress screens 122a, 122b using graphical representations 124, 126, 128, 130, 132, 134. Each graphical representation 124, 126, 128, 130, 132, 134 may also provide an indication of the current step being performed by apparatus 100 in preparing the beverage. For example, in FIG. 3 the BREWING step is highlighted with frame 132 and placement of barista icon 134 under the BREWING step to signify to the customer that this is the preparation step the beverage they ordered is currently experiencing. Each order progress screen 122a, 122b can display the name of the customer, the beverage ordered by the customer, and the amount of time remaining until the customer can pick up the beverage. When apparatus 100 is not preparing a beverage, the order progress screens 122a, 122b can display brand and/or product marketing content.

Referring to FIG. 1, order progress screen 122b is located on the right side of apparatus 100 (from the perspective of the customer) and the graphical representations displayed on order progress screen 122b shows the steps in the preparation of the beverage being performed in a right-to-left direction. If the graphical representations were instead displayed on order progress screen 122a, which is located on the left side of apparatus 100 (from the perspective of the customer), then graphical representations would show the steps in the preparation of the beverage being performed in a left-to-right direction (i.e., they would be displayed as mirror images of how they appeared on order progress screen 122b).

Apparatus 100 further includes a system landscape interface 136 which displays the order queue and is used to unlock the access doors 110a-110c, 110d-110f corresponding to pick-up points 106a-106c, 108a-108c at pick-up stations 106, 108. Like the first and second ordering interfaces 114a, 114b, system landscape interface 136 is preferably implemented with a touch-screen display, but it can also be implemented using other suitable means.

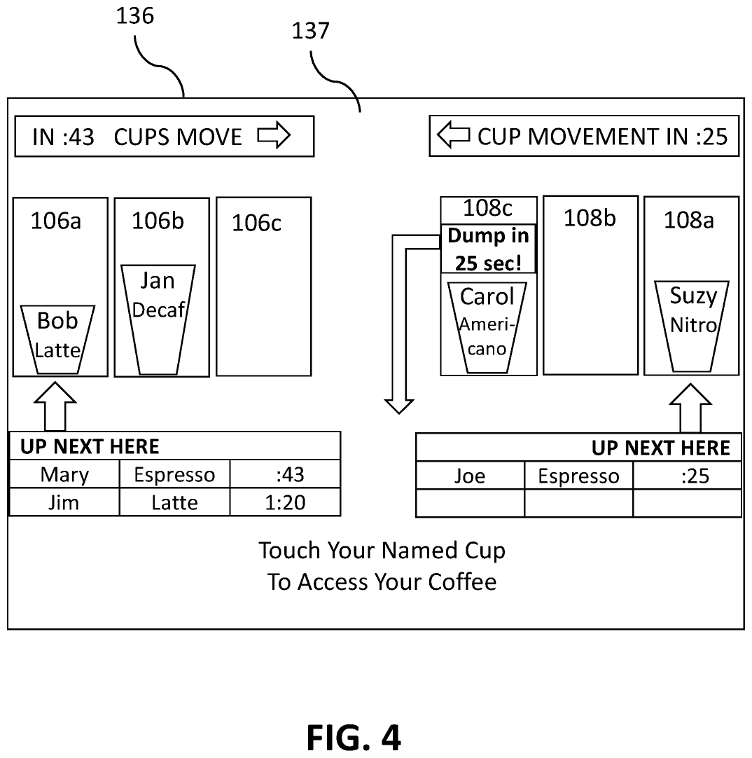

An exemplary system landscape interface 136 is shown in FIG. 4. As shown in FIG. 4, system landscape interface 136 displays a screen 137 which depicts the pick-up points 106a-106c at pick-up station 106 and pick-up points 108a-108c at pick-up station 108, as well as providing information about which customers' orders are ready to be picked up at which pick-up points. For instance, Bob's small latte is ready to be picked up at pick-up point 106a and Jan's large, decaffeinated coffee is ready to be picked up at pick-up point 106b; Carol's medium Americano is ready to be picked-up at pick-up point 108c; and Suzy's medium Nitro is ready to be picked up at pick-up point 108a.

In addition, system landscape interface 136 displays information to inform customers whose completed beverages will be added to pick-up points 106a, 108a next when the beverages will be added, when the cups at pick-up stations 106, 108 will move to different pick-up points, and when beverages that have not been picked up yet will be discarded. For instance, as shown in the screen 137 depicted in FIG. 4, at pick-up station 106 Mary's espresso will be delivered to pick-up point 106a in 43 seconds, when Jan's large, decaffeinated coffee is moved from pick-up point 106b to pick-up point 106c and Bob's small latte is moved from pick-up point 106a to pick-up point 106b. Jim's latte will be delivered to pick-up point 106a in 1 minute and 20 seconds. At pick-up station 108, Joe's espresso will be delivered to pick-up point 108a in 25 seconds, when Suzy's medium Nitro coffee will be moved from pick-up point 108a to pick-up point 108b and Carol's medium Americano will be dumped into the trash because it has not been picked up yet.

In a preferred embodiment of apparatus 100, access doors 110a-110f remain locked (e.g., using a magnetic lock) until a customer is ready to pick up his or her beverage. System landscape interface 136 can be used to unlock the access doors 110a-110f. As shown in FIG. 4, screen 137 displayed on system landscape interface 136 informs the customer that he or she can access his or her beverage by touching the graphical representation of its named cup displayed on system landscape interface 136, which will unlock the corresponding access door 110a-110f. In a preferred embodiment, apparatus 100 is configured such that only the customer can unlock the corresponding access door 110a-110f to access his or her completed beverage at the pick-up station 106, 108.

Apparatus 100 includes multiple, interchangeable beverage dispensing systems (which can include, for example, bean-to-cup coffee, drip coffee, espresso-based beverages, Nitro and cold-brew coffee, iced coffee, hot tea, and iced tea). Any one of the beverage dispensing systems included in apparatus 100 can be swapped out by field service personnel without disturbing other aspects of apparatus 100. The shapes and dimensions of the beverage dispensing systems employed within the structure of apparatus 100 can vary from one another. In a preferred embodiment, apparatus 100 measures about 5 feet wide, about 3 feet deep, and about 7 feet tall. Apparatus 100 may contain any combination of beverage dispensing systems, based on the preferences of local food-service operators.

In an exemplary embodiment of apparatus 100 shown in FIG. 5A, the beverage dispensing systems include a bean-to-cup coffee dispensing system 138, a specialty coffee dispensing system 140, and a cold brew and nitro coffee dispensing system 142. Apparatus 100 also includes an ice dispensing system 150. Bean-to-cup coffee dispensing systems, specialty coffee dispensing systems, cold brew and nitro coffee dispensing systems, and ice dispensing systems are known to the art and will not be discussed in detail here. In exemplary embodiments of apparatus 100 in accordance with the present invention, any number of the aforementioned dispensing systems could be used, and there could be more than one of any of these dispensing systems.

Cold brew and nitro coffee dispensing system 142 includes a source of cold brew coffee 145 (e.g., a bag of cold brew coffee concentrate in a box) and a nitro dispensing system (not shown) which are located in a refrigerator 144 of apparatus 100. Cold brew and nitro coffee dispensing system 142 also includes a Cold Brew cooling tower 146 which is provided between bean-to-cup coffee dispensing system 138 and specialty coffee dispensing system 140. If a customer orders a cold-brew or a nitrogen-infused cold-brew coffee, the Cold Brew cooling tower 146 cools the line 147 that delivers the cold-brew coffee from the refrigerator 144 to a dispensing head 143 which dispenses the cold-brew and nitrogen-infused cold-brew coffee into a cup.

Referring again to FIG. 5A, the source of cold brew coffee 145 sits on a load cell 151 in the refrigerator 144 to facilitate management of the amount of cold brew coffee that is present in the apparatus 100. The load cells 151 are monitored by the master controller 198 of apparatus 100. When the weight of the source of cold brew coffee 145 reaches or drops below a certain predetermined weight, the master controller 198 determines that the source of cold brew coffee 145 must be replenished or replaced.

Apparatus 100 also includes one or more reservoirs that hold “add-ins” which the customer can choose to include in the beverage order. Such add-ins can include, for example, flavorings (including but not limited to chocolate, caramel, vanilla, sugar-free vanilla, hazelnut, and chai), milks (dairy and/or non-dairy), nitrogen gas (for Nitro-infused cold brew coffee, as discussed above), ice, etc. For example, in addition to the Cold Brew cooling tower 146 described above, the apparatus 100 shown in FIG. 5A includes an ice dispenser 150 and a flavor station 152 which can include up to six bottles or bags-in-boxes (“BIB”) of flavored syrups 153. Refrigerator 144 stores up to six, one-gallon reservoirs of one or more types of dairy and/or non-dairy milks (including but not limited to half and half, whole milk, 2% milk, skim milk, oat milk, almond milk, etc.). As with the beverage dispensing systems 138, 140, 142, apparatus 100 may contain multiple, interchangeable reservoirs to provide any number of add-ins based on the preferences of local food-service operators.

Each of the one or more reservoirs that holds an add-in sits on its own load cell 151 to facilitate management of the amounts of add-ins that are present in apparatus 100. For instance, in flavor station 152, each bottle or BIB of flavored syrup 153 sits on its own load cell 151. The load cells 151 are monitored by the master controller 198 of apparatus 100 (see FIG. 8). When the weight of a particular bottle of flavored syrup 153 reaches or drops below a certain predetermined weight, the master controller 198 of apparatus 100 determines that the particular bottle must be replenished or replaced. Likewise, in the refrigerator 144, each reservoir of milk 148 sits on a load cell 151. When the weight of a particular reservoir of milk 148 reaches or drops below a certain predetermined weight, the master controller 198 of apparatus 100 determines that the particular reservoir of milk 148 must be replenished or replaced.

Referring now to FIGS. 1 and 5B, apparatus 100 includes one or more cup turret assemblies 154 which dispense the cups 156 that hold the prepared beverages. In a preferred embodiment, apparatus 100 includes four cup turret assemblies 154 and each cup turret assembly 154 dispenses cups 156 of a particular size, e.g., small, medium, large, or extra large. Here again, apparatus 100 may include any number of cup turret assemblies 154 and any combination of sizes of cups 156 based on the preferences of food-service operators. In preferred embodiments in accordance with the present invention, each cup turret assembly 154 is tall enough to hold about 100 cups each and is readily removable from and attachable to apparatus 100. Basically, the cup turret assemblies 154 can be snapped into and out of place in apparatus 100.

Each cup turret assembly 154 is configured to include a plurality of vertical spaces 166 each of which contains a sleeve of cups of a particular size. In a preferred embodiment, each cup turret assembly 154 is configured to include four vertical spaces 166. When all of the cups in a particular vertical space 166 of cup turret assembly 154 have been dispensed, the cup turret assembly 154 is rotated until another sleeve of cups 156 is positioned to drop into its corresponding cup dispenser 164.

In preferred embodiments, the vertical distance between each cup turret assembly 154 and its corresponding cup dispenser 164 is varied depending on the size of the cups contained in the cup turret assembly 154 to place the bottoms of the cups 156 that are next to be dropped from each of the cup dispensers 164 in the same horizontal plane 167 regardless of the size of the cup 156. In this way, the distances that the cups 156 drop from the cup dispensers 164 to the cup-transfer mechanisms of apparatus 100 (described below) are the same for each cup 156 regardless of cup size.

Apparatus 100 includes one or more automated first cup-transfer mechanisms 170 that receive the beverage cups 156 from the cup dispensers 164 and move the beverage cups 156 within apparatus 100 during the preparation of the customer's beverage. Referring to FIG. 5C, apparatus 100 includes two such automated first cup-transfer mechanisms 170a, 170b. Each first cup transfer mechanism 170a, 170b includes a rail 172 arranged along an x-axis of apparatus 100. In preferred embodiments, rails 172 are located above cup dispensers 164 to prevent beverages and (and add-ins) from spilling onto rails 172.

Each first cup transfer mechanism 170a, 170b also includes a cup support 174 which is configured to receive a cup 156 from one of the cup dispensers 164 and to move the cup along the length of rail 172 during the preparation of the customer's beverage. (Cups supports 174 are configured to accommodate all of the different top diameters of the different cup sizes that are supplied from cup turret assemblies 154 and cup dispensers 164). Specifically, after cup support 174 receives a cup 156 from one of the cup dispensers 164, cup support 174 first moves cup 156 to one of two laser engravers 176, which engrave information about the customer's beverage order onto cup 156. This information can take the form of a barcode (or a QR code, or the like) that enables a point-of-sale (“POS”) system at checkout to receive details of a beverage order (i.e., an identification of its specific ingredients), the customer's name, the name of the beverage that the customer ordered, and any other information that might be useful to the operator of apparatus 100 or to the customer. Marking information about the customer's beverage order directly onto cup 156 enables operators of apparatus 100 to properly charge their customers based on the specific ingredients of their customers' custom-made beverage orders by taking into account the beverage's “add-ins” (such as milks, flavorings, and sweeteners), rather than charging the customers based only on different cup sizes (e.g., small, medium, large, extra large). This benefit is made even easier by marking cup 156 with a bar code, a QR code, or the like that the operator's POS system can simply scan (as opposed to having to enter all of the add-ins into the POS system individually).

Cup support 174 then travels along rail 172 to move cup 156 to one or more of dispensing head 192 for bean-to-cup coffee dispensing system 138, dispensing head 194 for specialty coffee dispensing system 140, dispensing head 143 for cold brew and nitro coffee dispensing system 142, and dispensing head 196 for ice dispensing system 150, as applicable, from which the appropriate coffee and add-ins for the beverage that is being prepared by apparatus 100 are dispensed into cup 156.

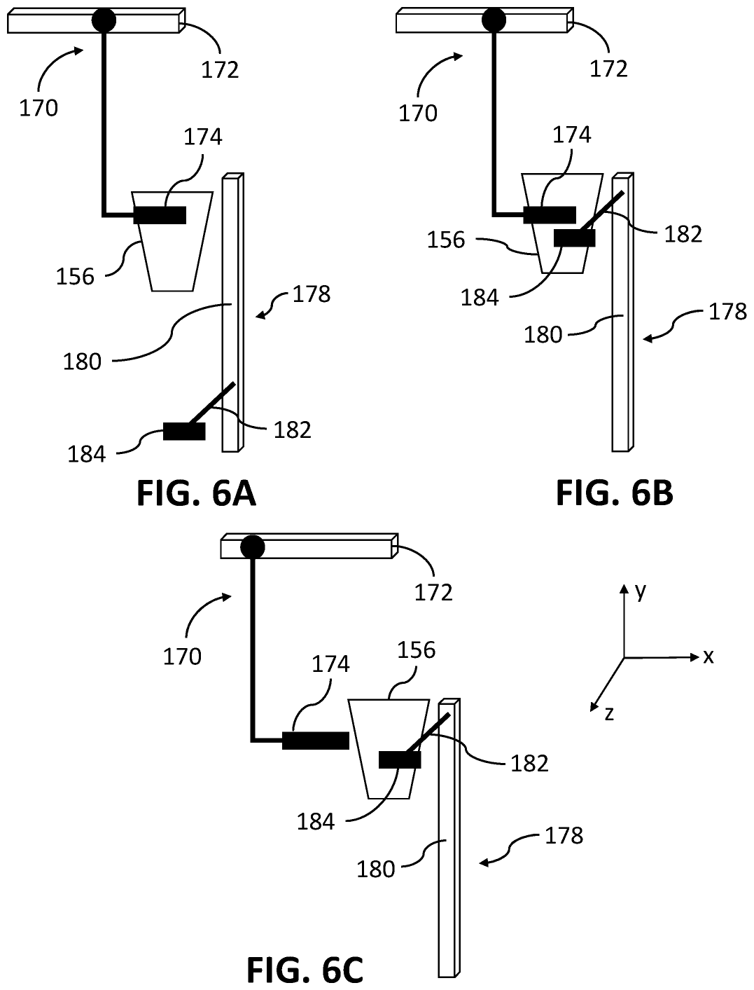

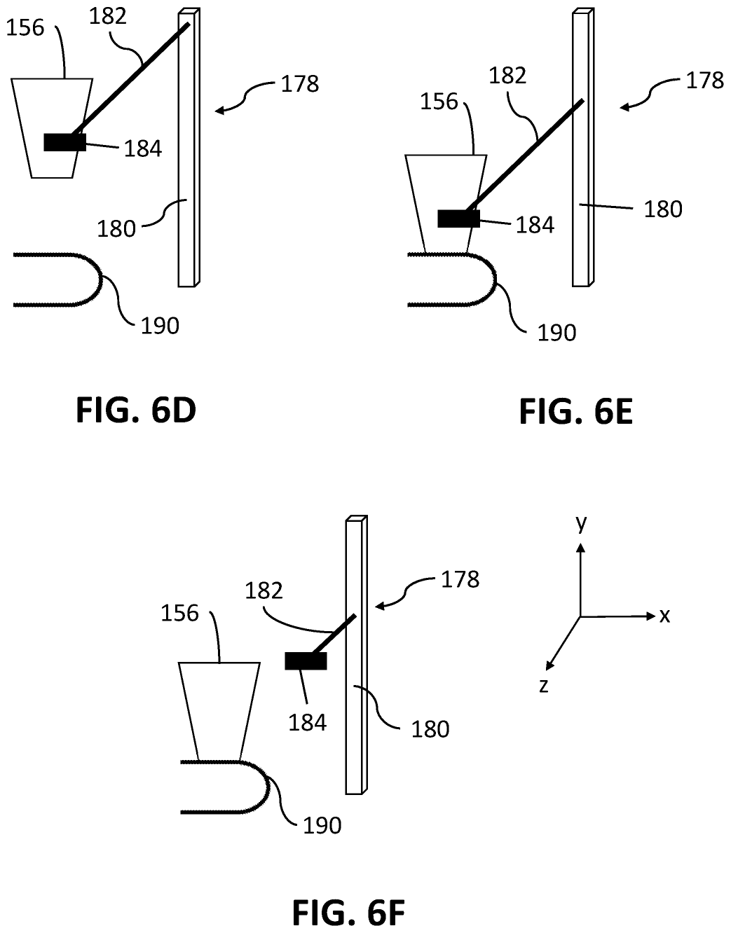

Apparatus 100 also includes one or more automated second cup-transfer mechanisms 178 which receive a cup 156 with a completed beverage from first cup-transfer mechanism 170 and deliver the completed beverage to first pick-up station 106 or to second pick-up station 108, as directed by master controller 198. Referring to FIG. 5C, apparatus 100 includes two such automated second cup-transfer mechanisms 178a, 178b which are located at opposite ends of the x-axis of the apparatus. Referring to FIGS. 6A-6F, each second cup transfer mechanism 178a, 178b includes a rail 180 arranged along a y-axis of apparatus 100 and a rail 182 arranged along a z-axis of apparatus 100. The x, y, and z axes of apparatus 100 are mutually perpendicular. A cup support 184 is configured to receive a cup 156 with the completed beverage from a cup support 174 of a first cup-transfer mechanism 170. Prior to receiving cup 156 from cup support 174 of first cup-transfer mechanism 170, cup support 184 is positioned at a bottom of rail 180, as shown in FIG. 6A. The size of cup support 184 is smaller than the size of cup support 174 so that cup support 184 engages cup 156 at a portion of cup 156 that is lower (and thus has a smaller diameter) than the portion of cup 156 that is engaged by cup support 174. When cup support 174 brings cup 156 with the completed beverage to second cup-transfer mechanism 178, cup support 184 travels upwardly along rail 180 until it receives cup 156 therein. Cup support 184 then continues to travel upwardly along rail 180 a little further until it lifts cup 156 out of cup support 174, as shown in FIG. 6B. Cup support 174 is then moved away from the second cup-transfer mechanism 178, as shown in FIG. 6C.

Following the transfer of cup 156 with the completed beverage from cup support 174 to cup support 184, rail 182 and cup support 184 are moved along rail 180 and rail 182 is extended to deliver cup 156 with the completed beverage to beverage pick-up station 106, 108 where it can be picked up by the customer. As shown in FIGS. 6D 6F, when the cup support 184 reaches a position over pick-up station 106, 108, cup support 184 is lowered along rail 180 to set cup 156 down on an automated conveyor 190 at pick-up station 106, 108.

Referring still to FIGS. 1 and 7, in a preferred embodiment, each one of beverage pick-up stations 106, 108 includes its own automated conveyor 190a, 190b which holds completed beverages and moves them to make room for the next completed beverage without requiring human interaction. Those skilled in the art will appreciate that other mechanisms and systems that can hold completed beverages and move them to make room for the next completed beverage without requiring human interaction (such as, for example, turntables) can be used in place of conveyors 190a, 190b in alternative embodiments in accordance with the present invention.

In a preferred embodiment, automated conveyor 190a is configured to have three pick-up points 106a, 106b, 106c, and automated conveyor 190b is configured to have three pick-up points 108a, 108b, 108c. However, automated conveyors 190a, 190b may be configured to include more or fewer pick-up points (e.g., two or four). In a preferred embodiment, each automated conveyor 190a, 190b is located on a rear side of a front door 103a, 103b (i.e., on the side of front door 103a, 103b that is facing into housing 102 when doors 103a, 103b are closed). Thus, automated conveyors 190a, 190b move outside of housing 102 when doors 103a, 103b are opened. This enables easier cleaning of the beverage dispensing and cup movement areas located within housing 102 of apparatus 100.

After preparation of a beverage is completed and the completed beverage has been transferred from first cup-transfer mechanism 170 to second cup-transfer mechanism 178, the appropriate automated conveyor 190a, 190b rotates so that pick-up point 106a (or pick-up point 108a) is available to receive the cup 156 with the completed beverage. The second cup-transfer mechanism 178 then places the cup 156 with the completed beverage onto pick-up point 106a (or 108a) in the manner described above with reference to FIGS. 6A-6F.

In a preferred embodiment, master controller 198 causes access doors 110a-110f at pick-up stations 106, 108 to be locked when automated conveyors 190a, 190b rotate to receive the cup 156 with the next completed beverage. Screen 137 displayed on system landscape interface 136 notifies the customer when the access door 110a-110f corresponding to his or her completed beverage is about to be locked, when that access door is locked, and when that access door can be opened.

In a preferred embodiment of apparatus 100, an opening 186 is provided between the two pick-up stations 106, 108. The opening 186 allows a completed beverage order to be discarded from a pick-up station 106, 108 into a collection area 188 if a customer does not pick up the completed beverage order within an allotted amount of time. Specifically, when conveyors 190a, 190b rotate, cups 156 with completed beverages that are located at pick up points 106c and 108c will drop off the corresponding conveyor 190a, 190b into collection area 188 through opening 186. Thus, conveyors 190a, 190b also eliminate the potential for a “log jam” in apparatus 100 due to beverages that have not been picked up. Specifically, if a customer does not pick up his or her beverage before the expiration of an allotted time window following completion of the preparation of the beverage, the beverage will drop off the conveyors 190a, 190b and into collection area 188 through opening 186 to make room for subsequent completed beverages.

In embodiments in accordance with the present invention, a cup 156 holding a completed beverage which is sitting on a conveyor 190a, 190b will be dropped from its conveyor 190a, 190b into collection area 188 after three subsequent beverage orders have been placed and completed and are presented for placement onto the same conveyor 190a, 190b. Thus, when the third subsequent beverage order is completed and is presented for placement onto the same conveyor 190a, 190b, the cup 156 holding a completed beverage which was initially sitting on the conveyor 190a, 190b will be dropped from its conveyor 190a, 190b into collection area 188. Until and unless at least three subsequent beverage orders are completed and presented for placement onto the same conveyor 190a, 190b, the cup 156 holding a completed beverage which was initially sitting on the conveyor 190a, 190b will remain on its conveyor 190a, 190b without being discarded. (As will be understood by those skilled in the art, the number of subsequent beverage orders referred to in this paragraph will vary according to the number of pick-up points provided on the conveyor 190a, 190b.)

In preferred embodiments in accordance with the present invention, the allotted time window for the customer to pick up his or her completed beverage after it is placed on a conveyor 190a, 190b is extended by alternating which pick-up station 106, 108 (and thus which conveyor 190a, 190b) the next completed order is delivered to. Thus, if a completed beverage order is delivered to left pick-up station 106 and placed on one of the pick-up points 106a-106c on conveyor 190a, master controller 198 will cause the next completed beverage order to be delivered to right pick-up station 108 and placed on one of the pick-up points 108a-108c on conveyor 190b, and so on. In this way, the allotted time window between placement of a beverage order by a customer and discarding the completed beverage from a conveyor 190a, 190b because it has not been picked up by the customer is extended from the time it takes to place and prepare three subsequent beverage orders to the time it takes to place and prepare six subsequent beverage orders. (As will be understood by those skilled in the art, the number of subsequent beverage orders referred to in this paragraph will vary according to the number of pick-up points provided on the conveyor 190a, 190b.)

Referring to FIG. 5C, apparatus 100 includes infrared cameras 177, which are coupled to master controller 198. Infrared cameras 177 enable apparatus 100 to verify various aspects of the beverage ordered by the customer, including the size of the cup that contains the beverage, the level of the beverage contained within the cup, and the approximate temperature of the beverage contained within the cup.

FIG. 8 provides a block diagram illustrating the interaction between master controller 198 of apparatus 100 and various components and systems of apparatus 100 which enable master controller 198 to exercise overall control of the automated operations of apparatus 100 as described herein. Other components and systems that are included in apparatus 100 but which have not been described herein or shown in the drawings to avoid unnecessary complication include, but are not limited to: various subsidiary control boards; motors and limit switches for first and second cup-transfer mechanisms 170, 178 and automated conveyors 190; pumps for pumping Cold Brew, milk, and flavorings, from their respective reservoirs 145, 148, 153 to beverage dispensing systems 138, 140, 142 and/or dispensing heads 143, 192, 194, 196, as appropriate; additional sensors; and Ethernet switches.

Even though apparatus 100 includes various beverage delivery systems, it is powered by a single electrical power plug and requires only two plumbing connections, one to a supply of water and a second one to a drain.

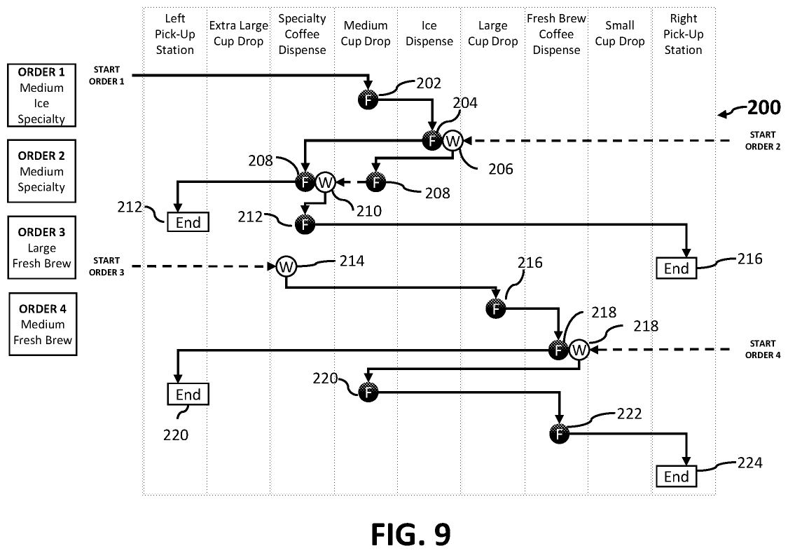

In accordance with an additional aspect of the present invention, multiple beverages can be in the process of being prepared and delivered simultaneously within the limited space of apparatus 100 to increase the throughput of apparatus 100. Referring now to FIG. 9, a process 200 is shown whereby, in a preferred embodiment in accordance with the present invention, apparatus 100 moves the first cup transfer mechanisms 170a, 170b in such a way that one of first cup transfer mechanisms 170a, 170b is moved as close as possible to a function point (“F”) of apparatus 100 and it waits (“W”) until that function point is vacated by the other first cup transfer mechanism 170a, 170b. This process 200, which can be thought of as an “optimized shadowing” on the part of the first cup transfer mechanisms 170a, 170b, minimizes the travel distance (and, thus, travel time) for all moves of the first cup transfer mechanisms 170a, 170b, thereby minimizing the amount of time required to complete a plurality of beverage orders.

FIG. 9 illustrates optimized shadowing process 200 with four beverage orders in the order queue of apparatus 100: a Medium Iced Specialty coffee (Order 1), a Medium Specialty coffee (Order 2), a Large Fresh Brew coffee (Order 3), and a Medium Fresh Brew coffee (Order 4). (Orders 1-4 are numbered in the order in which they were received by apparatus 100.) In step 202, apparatus 100 starts the preparation of Order 1 by moving first cup transfer mechanism 170a from left pick-up station 106 to the cup dispenser 164 which dispenses medium-sized cups (i.e., the “Medium Cup Drop”). In step 204, first cup transfer mechanism 170a moves the medium cup to the ice dispenser 150 (i.e., the “Ice Dispense”), where ice is added to it.

Simultaneously with step 204 (or slightly before), in step 206 apparatus 100 starts the preparation of Order 2 by moving the first cup transfer mechanism 170b toward the Medium Cup Drop and it is held in a position just short of the Medium Cup Drop while first cup transfer mechanism 170a is still there. In step 208, first cup transfer mechanism 170a moves from the Ice Dispense point to the Specialty Coffee Dispense point and, simultaneously, first cup transfer mechanism 170b completes its move to the Medium Cup Drop. In step 210, first cup transfer mechanism 170b begins to move towards the Specialty Coffee Dispense point and is held in a position just short of the Specialty Coffee Dispense point while first cup transfer mechanism 170a is still there. In step 212, first cup transfer mechanism 170a moves its cup to left pick-up station 106 and, simultaneously, first cup transfer mechanism 170b completes its move to the Specialty Coffee Dispense point.

In step 214, the apparatus 100 starts the preparation of Order 3 by moving first cup transfer mechanism 170a from left pick-up station 106 toward the cup dispenser 164 which dispenses large-sized cups (i.e., the “Large Cup Drop”) but it is held in a position just short of the Specialty Coffee Dispense point while first cup transfer mechanism 170b is still there. In step 216, first cup transfer mechanism 170b moves to right pick-up station 108 and, simultaneously, first cup transfer mechanism 170a completes its move to the Large Cup Drop. In step 218, first cup transfer mechanism 170a moves to the Fresh Brew Coffee Dispense point and, simultaneously, the apparatus 100 starts the preparation of Order 4 by moving first cup transfer mechanism 170b from right pick-up station 108 toward the Medium Cup Drop. However, first cup transfer mechanism 170b is held in a position just short of the Fresh Brew Coffee Dispense point while first cup transfer mechanism 170a is still there.

In step 220, first cup transfer mechanism 170a moves its cup to left pick-up station 106 and, simultaneously, first cup transfer mechanism 170b completes its move to the Medium Cup Drop. In step 222, first cup transfer mechanism 170b moves to the Fresh Brew Coffee Dispense point. Finally, in step 224, the first cup transfer mechanism 170b moves to right pick-up station 108.

Different beverages—and beverage sizes—are more favored at certain times of day (and in certain store locations) than others. For example, Cold Brew coffees and Iced coffees may be more popular (i.e., may have a higher historical likelihood of being ordered) than hot beverages in the afternoon at certain store locations. Likewise, in stores in rural locations, large and medium beverage sizes may be more popular than small and extra large beverage sizes, whereas in stores located in college campuses, the opposite may be true. Since preparation of all beverage products in apparatus 100 starts by moving the first cup transfer mechanisms 170a, 170b to the cup drop position of the ordered cup size, in preferred embodiments in accordance with the present invention, the total start-to-finish time for completing all of the beverage orders in the order queue of apparatus 100 can be reduced in several ways. In one embodiment, the first cup transfer mechanisms 170a, 170b of apparatus 100 are pre-positioned at locations along rail 172 that are nearest to the cup drop locations of the most popular cup sizes at a given store location at certain times of day. In another embodiment, apparatus 100 pre-dispenses a cup 156 having the most popular cup size to one of the first cup transfer mechanisms 170a, 170b. For example, if the most popular cup size is medium, then apparatus 100 will pre-dispense a medium cup 156 to first cup transfer mechanism 170a. After the cup 156 is pre-dispensed to first cup transfer mechanism 170a, if the next beverage order is for a beverage having the same cup size as the size of the pre-dispensed cup 156 (i.e., medium), then that beverage order will be prepared using first cup transfer mechanism 170a, which already has a pre-dispensed, medium cup 156. However, if the next beverage order is for a beverage having a different cup size than the cup size of the pre-dispensed cup 156 (e.g., large), then that beverage order will be prepared using first cup transfer mechanism 170b (i.e., the other one of first cup transfer mechanisms 170a, 170b).

While the large beverage order is being prepared using first cup transfer mechanism 170b, if the next beverage order is once again for a beverage having a different cup size than the medium cup size of the pre-dispensed cup 156 in first cup-transfer mechanism 170a (e.g., small), then the empty, pre-dispensed cup 156 in first cup-transfer mechanism 170a is transferred to a pick-up station 106, 108 and is ultimately dropped into collection area 188, as described above. This frees first cup-transfer mechanism 170a to prepare that next beverage order.

In embodiments in accordance with the present invention, the total start-to-finish time for completing all of the beverage orders in the order queue of apparatus 100 can also be reduced by the configuration or reconfiguration of the interior components and systems within apparatus 100. In one embodiment, the cup turret assembly 154 and its corresponding cup dispenser 164 for the most popular cup size are located nearest to the dispense head 143, 192, 194, 196 for the most popular beverage. This minimizes travel distances for the cups 156 and thus reduces the total start-to-finish time for completing all of the beverage orders in the order queue of apparatus 100.

In another embodiment, the cup turret assemblies 154 and their corresponding cup dispensers 164 for the two most popular cup sizes are centrally located within apparatus 100 and the cup turret assemblies 154 and their corresponding cup dispensers 164 for the two least popular cup sizes are peripherally located within apparatus 100, which will optimize beverage throughput of apparatus 100 at a given store location. For instance, in stores in rural locations, the two most popular cup sizes may be large and medium. Thus, for those store locations, the cup turret assemblies 154 and their corresponding cup dispensers 164 for the large and medium cup sizes are centrally located within apparatus 100 and the cup turret assemblies 154 and their corresponding cup dispensers 164 for the small and extra large cup sizes are peripherally located within apparatus 100. In contrast, in stores located in college campuses, the two most popular cup sizes may be small and extra large. Thus, for those store locations, the cup turret assemblies 154 and their corresponding cup dispensers 164 for the small and extra large cup sizes are centrally located within apparatus 100 and the cup turret assemblies 154 and their corresponding cup dispensers 164 for the medium and large cup sizes are peripherally located within apparatus 100.

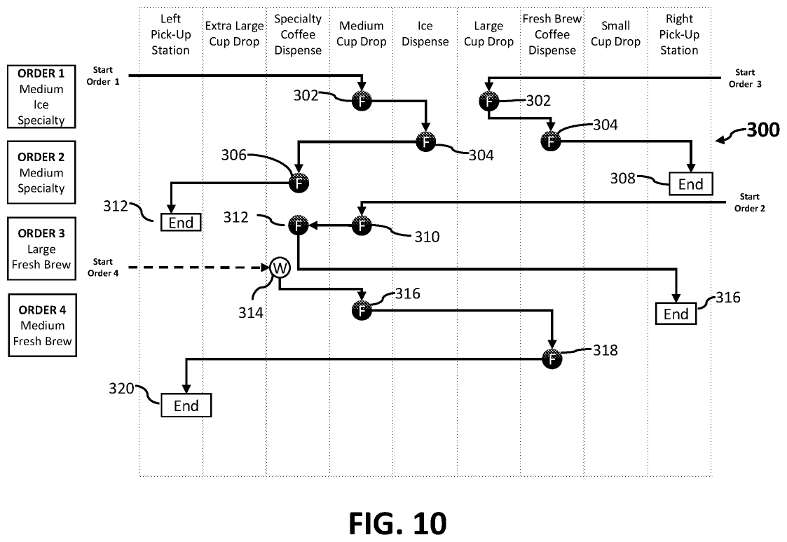

In accordance with an additional aspect of the present invention, in preferred embodiments the throughput of apparatus 100 can be increased by managing the order queue of apparatus 100 to move a “non-conflicting” order ahead of other orders in the order queue that were received before the non-conflicting order, thereby reducing the total start-to-finish time of completing all of the beverage orders in the order queue. FIG. 10 illustrates a process 300 with four beverage orders in the order queue of apparatus 100: a Medium Iced Specialty coffee (Order 1), a Medium Specialty coffee (Order 2), a Large Fresh Brew coffee (Order 3), and a Medium Fresh Brew coffee (Order 4). (Orders 1-4 are numbered in the order in which they were received by apparatus 100.) As shown in FIG. 10, Order 1 and Order 2 are both Medium Specialty beverages, whereas Order 3 is a Large Fresh Brew beverage. Therefore, Order 3 can be moved ahead of Order 2 in the order queue because there is no conflict between Order 1 and Order 3.

In step 302, apparatus 100 starts the preparation of Order 1 by moving first cup transfer mechanism 170a from left pick-up station 106 to the Medium Cup Drop and, simultaneously, starts the preparation of Order 3 by moving first cup transfer mechanism 170b from right pick-up station 108 to the Large Cup Drop. In step 304, first cup transfer mechanism 170a moves to the Ice Dispense point, where ice is added to Order 1 and, simultaneously, first cup transfer mechanism 170b moves to the Fresh Brew Coffee Dispense point. In step 306, first cup transfer mechanism 170a moves to the Specialty Coffee Dispense point. In step 308, first cup transfer mechanism 170b moves to the right pick-up station 108.

In step 310, apparatus 100 starts the preparation of Order 2 by moving first cup transfer mechanism 170b to the Medium Cup Drop. In step 312, first cup transfer mechanism 170a moves to the left pick-up station 106 and, simultaneously, first cup transfer mechanism 170b moves to the Specialty Coffee Dispense point. In step 314, the apparatus 100 starts the preparation of Order 4 by moving first cup transfer mechanism 170a from left pick-up station 106 toward the Medium Cup Drop but it is held in a position just short of the Specialty Coffee Dispense point while first cup transfer mechanism 170b is still there. In step 316, first cup transfer mechanism 170b moves to the right pick-up station 108 and, simultaneously, first cup transfer mechanism 170a completes its move to the Medium Cup Drop. In step 318, first cup transfer mechanism 170a moves to the Fresh Brew Coffee Dispense point. Finally, in step 320, first cup transfer mechanism 170a moves to the left pick-up station 106.

Another example of optimized sequencing arises because Specialty Coffees are dispensed from a different function point in apparatus 100 than Fresh Brewed, Nitro, and Cold Brew coffees. Accordingly, the sequence of order processing when multiple orders are in the order queue can affect the total start-to-finish time for completing the beverage orders in the order queue. For example, if two orders each for Specialty and Fresh Brewed beverages are in the order queue of an apparatus 100 located in a store which has a higher historical likelihood of Specialty coffees being ordered at that store at that time of day, apparatus 100 may start the Specialty coffee orders first-even if they were not the first orders to enter the order queue—in order to maximize throughput per unit time of apparatus 100.

The function points of apparatus 100 shown in FIGS. 9 and 10 (i.e., Left Pick-Up Station, Extra Large Cup Drop, Specialty Coffee Dispense, Medium Cup Drop, Ice Dispense, Large Cup Drop, Fresh Brew Coffee Dispense, Small Cup Drop, and Right Pick-Up Station) could be provided in a different order. Also, different function points could be provided.

As has been described, the present invention provides an apparatus and method for automated preparation and delivery of beverages which has multiple, interchangeable beverage dispensing systems and is thus capable of preparing and serving a wide range of high-quality beverage products in a small space at a high throughput without human assistance.

While the present invention has been described in conjunction with exemplary embodiments outlined above and illustrated in the drawings, it is evident that many alternatives, modifications and variations in form and detail will be apparent to those skilled in the art. In addition, although the exemplary embodiments outlined above and illustrated in the drawings relate to the automated preparation and delivery of coffee and tea beverages, those skilled in the art will appreciate that the present invention is not limited to an apparatus for the automated preparation and delivery of these types of beverages. Specifically, the present invention can be embodied in any apparatus used in a setting where high beverage throughput is required from a small space without requiring human assistance. For instance, the present invention could be embodied in an apparatus for the automated preparation and delivery of beverages containing alcoholic spirits. Accordingly, the exemplary embodiments of the invention, as set forth above, are intended to be illustrative, not limiting, and the spirit and scope of the present invention is to be construed broadly and limited only by the appended claims, and not by the foregoing specification.

What is claimed is:

1. An apparatus for automated preparation and delivery of a beverage ordered by a customer, the apparatus comprising:
a plurality of cup dispensers, wherein at least one of the plurality of cup dispensers is configured to dispense a cup which is appropriate to contain the beverage ordered by the customer;
a first cup-transfer mechanism configured to receive the cup from one of the plurality of cup dispensers and to move the cup along a first axis within the apparatus during the preparation of the beverage ordered by the customer;
a second cup-transfer mechanism configured to receive the cup containing the beverage ordered by the customer from the first cup-transfer mechanism after the beverage has been prepared, wherein the second cup-transfer mechanism is configured to move the cup along at least one of a second axis and a third axis within the apparatus, wherein the first axis, the second axis, and the third axis are mutually perpendicular; and
a pick-up station from which the cup containing the beverage ordered by the customer is picked up by the customer, wherein the pick-up station is configured to receive the cup containing the beverage ordered by the customer from the second cup-transfer mechanism and to make room to receive subsequent cups without requiring human interaction.

2. The apparatus of claim 1, wherein the pick-up station comprises a conveyor.

3. The apparatus of claim 2, wherein the apparatus further comprises at least one front door and the conveyor is located on the at least one front door.

4. The apparatus of claim 2, wherein the conveyor rotates such that the cup containing the beverage ordered by the customer is dropped from the conveyor if the customer has not picked up the cup containing the beverage ordered by the customer from the conveyor within an allotted period of time.

5. The apparatus of claim 1, wherein the apparatus comprises two pick-up stations which are located at least about 2.5 feet from each other.

6. The apparatus of claim 5, wherein each of the two pick-up stations comprises a conveyor.

7. The apparatus of claim 6, wherein each of the conveyors rotates such that the cup containing the beverage ordered by the customer is dropped from the conveyor if the customer has not picked up the cup containing the beverage from the conveyor within an allotted amount of time.

8. The apparatus of claim 7, wherein the allotted amount of time is extended by delivering the cup containing the beverage ordered by the customer to a first one of the two pick-up stations and alternating delivery of subsequently ordered beverages between a second one of the two pick-up stations and the first one of the two pick-up stations.

9. The apparatus of claim 1, wherein the apparatus comprises a plurality of first cup-transfer mechanisms.

10. The apparatus of claim 9, wherein the apparatus comprises two first cup-transfer mechanisms.

11. The apparatus of claim 1, wherein the apparatus comprises a plurality of second cup-transfer mechanisms.

12. The apparatus of claim 11, wherein the apparatus comprises two second cup-transfer mechanisms, each of the two second cup-transfer mechanisms being located at an opposite end of the first axis of the apparatus.

13. The apparatus of claim 2, wherein the second cup-transfer mechanism moves the cup containing the beverage ordered by the customer along the second axis and/or the third axis to place the cup on the conveyor.

14. The apparatus of claim 9, wherein each of the two first cup-transfer mechanisms handles cups having different top diameters.

15. The apparatus of claim 1, wherein the bottoms of the cups that extend from each of the plurality of cup dispensers are in the same horizontal plane.

16. The apparatus of claim 1, wherein the first cup-transfer mechanism and the second cup-transfer mechanism are located above the cup containing the beverage ordered by the customer.

17. The apparatus of claim 1, further comprising:
a controller; and
an infrared camera coupled to the controller to verify one or more of: the size of the cup that contains the beverage ordered by the consumer, the level of the beverage contained within the cup, and the approximate temperature of the beverage contained within the cup.

18. The apparatus of claim 1, wherein:
each of said plurality of cup dispensers comprises a turret assembly configured to hold a plurality of sleeves of cups; and
when the cup dispenser has dispensed all of the cups from a first sleeve of the plurality of sleeves of cups held in the turret assembly, the turret assembly moves a second sleeve of the plurality of sleeves of cups held in the turret assembly into a position where the cup dispenser can dispense cups from the second sleeve.

19. The apparatus of claim 18, wherein the turret assembly is readily removable from and attachable to the apparatus.

20. The apparatus of claim 1, further comprising at least one door granting access to the pick-up station.

21. The apparatus of claim 20, wherein access to the pick-up station via the at least one door is granted only to the customer.

22. The apparatus of claim 2, further comprising at least one door granting access to the pick-up station, wherein the at least one door is locked when the conveyor is moving.

23. The apparatus of claim 22, further comprising a display which notifies the customer when the at least one door is about to be locked, when the at least one door is locked, and/or when the at least one door can be opened.

24. A method for automated preparation and pick-up of a beverage ordered by a customer, the method comprising:
dispensing a cup which is appropriate to contain the beverage ordered by the customer;
receiving the cup in a first cup-transfer mechanism;
moving the cup along a first axis by the first cup-transfer mechanism during preparation of the beverage ordered by the customer;
transferring the cup containing the beverage ordered by the customer from the first cup-transfer mechanism to a second cup-transfer mechanism after the beverage has been prepared, wherein the second cup-transfer mechanism is configured to move along at least one of a second axis and a third axis, wherein the first axis, the second axis, and the third axis are mutually perpendicular;
receiving the cup with the beverage ordered by the customer from the second cup-transfer mechanism at a location from which the cup containing the beverage ordered by the customer is picked up by the customer; and
making room at the location to receive subsequent cups without requiring human interaction.

25. The method of claim 24, wherein the second receiving step comprises placing the cup containing the beverage ordered by the customer on a conveyor using the second cup-transfer mechanism.

26. The method of claim 25, further comprising rotating the conveyor such that the cup containing the beverage ordered by the customer is dropped from the conveyor if the customer has not picked up the cup containing the beverage ordered by the customer from the conveyor within an allotted amount of time.

27. The method of claim 25, comprising placing the cup containing the beverage ordered by the customer on the conveyor by moving the cup along the second axis and/or the third axis.

28. The method of claim 24, comprising providing a plurality of locations from which the cup containing the beverage ordered by the customer can be picked up by the customer.

29. The method of claim 28, wherein each of the plurality of locations comprises a conveyor.

30. The method of claim 29, comprising rotating each of the conveyors such that the cup containing the beverage ordered by the customer is dropped from the conveyor if the customer has not picked up the cup containing the beverage from the conveyor within an allotted amount of time.

31. The method of claim 30, comprising extending the allotted amount of time by delivering the cup containing the beverage ordered by the customer to a first one of the plurality of locations and alternating delivery of subsequently ordered beverages between a second one of the plurality of locations and the first one of the plurality of locations.

32. The method of claim 24, further comprising the step of handling, by the first cup-transfer mechanism, cups having different top diameters.

33. The method of claim 24, wherein the dispensing step comprises dropping the cup from a predetermined distance that remains constant regardless of a size to the cup.

34. The method of claim 24, further comprising the step of locating the first cup-transfer mechanism and the second cup-transfer mechanism above the cup containing the beverage ordered by the customer.

35. The method of claim 24, further comprising the step of verifying one or more of: the size of the cup that contains the beverage ordered by the consumer, the level of the beverage contained within the cup, and the approximate temperature of the beverage contained within the cup.

36. The method of claim 24, wherein the dispensing step comprises:
holding a plurality of sleeves of cups in a turret assembly; and
when all of the cups from a first sleeve of the plurality of sleeves of cups held in the turret assembly have been dispensed, moving a second sleeve of the plurality of sleeves of cups held in the turret assembly into a position where cups from the second sleeve can be dispensed.

37. The method of claim 24, further comprising the step of granting access to the pick-up station via at least one door.

38. The method of claim 37, wherein access to the pick-up station via the at least one door is granted only to the customer.

39. The method of claim 25, further comprising:
granting access to the pick-up station via at least one door; and
locking the at least one door when the conveyor is moving.

40. The method of claim 39, further comprising the step of notifying the customer when the at least one door is about to be locked, when the at least one door is locked, and/or when the at least one door can be opened.

41. An apparatus for automated preparation and delivery of a beverage ordered by a customer, the apparatus comprising:
a plurality of cup dispensers, wherein at least one of the plurality of cup dispensers is configured to dispense a cup which is appropriate to contain the beverage ordered by the customer;
a cup-transfer mechanism configured to receive the cup and to move the cup along a first axis within the apparatus during the preparation of the beverage ordered by the customer; and
a laser configured to mark information about the beverage ordered by the customer directly onto the cup, whereby an operator of the apparatus can charge the customer based on the information.

42. The apparatus of claim 41, wherein the information identifies specific ingredients of the beverage ordered by the customer.

43. The apparatus of claim 42, wherein the information comprises a barcode.

44. The apparatus of claim 42, wherein the information comprises a QR code.

45. A method for automated preparation and pick-up of a beverage ordered by a customer, the method comprising:
dispensing a cup which is appropriate to contain the beverage ordered by the customer;
receiving the cup in a first cup-transfer mechanism;
moving the cup along a first axis by the first cup-transfer mechanism during preparation of the beverage ordered by the customer; and
marking information about the beverage ordered by the customer directly onto the cup, whereby an operator of the apparatus can charge the customer based on the information.

46. The method of claim 45, wherein the information identifies specific ingredients of the beverage ordered by the customer.

47. The method of claim 46, wherein the information comprises a barcode.

48. The method of claim 47, further comprising scanning the barcode at a point-of-sale system.

49. The method of claim 46, wherein the information comprises a QR code.

50. The method of claim 49, further comprising scanning the QR code at a point-of-sale system.
